(19) United States
(12) Patent Application Publication
(10) Pub. No.: US 2004/0265600 A1
(43) Pub. Date: Dec. 30, 2004

(54) Material for forming copper undercoat films

(76) Inventor: Hideaki Machida, Kitatsura-Gun (JP)

Correspondence Address: MCKENNA LONG & ALDRIDGE LLP, Song K. Jung, 1900 K Street, N.W., Washington, DC, 20006, US

(21) Appl. No.: 10/732,812

(22) Filed: Dec. 11, 2003

(30) Foreign Application Priority Data
Dec. 12, 2002 (JP) 542036JP01

(51) Int. Cl. B32B 9/04

(52) U.S. Cl. 428/447

(57) ABSTRACT

An undercoat film that prevents copper diffusion and has excellent copper conductor film binding, even when thin. In addition, a material for forming a copper undercoat film, characterized by a compound represented by the general formula: (R₁R₂)P—(R)ₙ—Si (X₁X₂X₃), wherein at least one of X₁,X₂ and X₃ is a hydrolytic group, R₁ and R₂ are alkyl groups, R denotes a chain-form organic group formed from alkyl groups, aromatic rings or alkyl groups containing aromatic rings, and n is an integer from 1 to 6.

This application claims the benefit of Japanese Patent Application No. 542036JP01, filed on Dec. 12, 2002, which is hereby incorporated by reference for all purposes as if fully set forth herein.

### BACKGROUND

In recent years, advances in LSI technologies have been rapid, and reduction in the size of LSI chips has been pursued. In conjunction therewith, the width of conductors that transmit signals has also decreased, leading to ultra-fine detail. In conventional W films, and in Al films as well, the resistance of the materials does not allow an increase in levels of detail, and thus the use of copper having low resistance has been proposed.

However, when copper having low resistance is used, a number of problems arise that are not present with W or Al. One of these problems is the diffusion of copper into its surroundings. When copper diffuses into its surroundings, this has serious detrimental effects in terms of function of the LSI chip. Thus, the use of alloy films as copper diffusion barriers (barrier metals, eg, TiN, TaW, ZrN, VN and TiSiN) has been offered, where the film is provided as an undercoat film.

Now, in order for the aforementioned alloy film to function effectively as a barrier metal, there is a limit to the reduction in alloy film thickness, since if the film is too thin, it will not act as a barrier metal. On the other hand, it has been predicted that the thickness of copper conductor films may decrease to below 0.1 μm in the future. For this reason, if the thickness of barrier metals cannot be reduced, then the thickness of the copper conductor film must be reduced in accordance with this decrease, and if the width of the copper conductor film is to be reduced to less than 0.1 μm, then the cross-sectional surface area of the copper conductor film will decrease. Currently, there is uncertainty regarding the use of low-resistance copper as conductor, whatever the reason.

Specifically, limitations on the above types of alloy films have now been identified.

A second problem that may be cited is the degradation of adhesion between copper and the undercoating. For example, when the undercoat film is Si or SiO₂, the copper film (plated copper film or CVD copper film) readily peels. In particular, when Ta-based film, considered to the most effective of the aforementioned barrier metals, is provided as an undercoat film, the binding thereof is considered to be extremely poor, and there are even cases where the material peels during copper film formation.

Consequently, the problem to be solved by the present invention is to offer a novel undercoat film that can be used in place of the above types of barrier metals.

In particular, the problem is to offer an undercoat film that has superior binding with respect to copper conductor film, while also preventing copper diffusion, even when formed in films that are thinner than with the aforementioned barrier metals.

### SUMMARY OF THE INVENTION

As a result of painstakingly pursuing research and development regarding the above problems, it was discovered that the organic phosphorus-silicon system molecular film ((R₁R₂)P—(R)ₙ—Si-0) effectively prevents copper diffusion, and has excellent binding with respect to copper films, even at thicknesses of a few tens of angstroms.

The present invention was perfected based on this knowledge, and the aforementioned problems are thus solved by means of a material for forming copper undercoat films comprising the compound represented by general formula (1) below:

(R₁R₂)P—(R)ₙ—Si(X₁X₂X₃)

In general formula (I), at least one of X₁, X₂ and X₃ is a hydrolytic group, R₁ and R₂ are alkyl groups, R denotes a chain-form organic group formed from alkyl groups, aromatic rings or alkyl groups containing aromatic rings, and n is an integer from 1 to 6.

In particular, the problems are solved by means of a material for forming copper undercoat films, characterized by a compound represented by general formula (I). In general formula (I), at least one of X₁, X₂ and X₃ is selected from a group comprising halogens, alkoxide groups, amino groups and isocyanate groups, R₁ and R₂ are alkyl groups with carbon numbers of 1-21, R has a carbon number of 1-50, and denotes a chain-form organic group formed from alkyl groups, aromatic rings or alkyl groups containing an aromatic rings, and n is an integer from 1 to 6.

The problem is solved by a material for forming copper undercoat films, characterized by one or more compounds selected from a group consisting of 1-dimethylphosphino-2-triethoxysilylethane, 1-diethylphosphino-2-triethoxysilylethane, 1-diphenylphosphino-2-triethoxysilylethane, 1-dimethylphosphino-2trimethoxysilylethane, 1-diethylphosphino-2-trimethoxysilylethane, 1-diphenylphosphino-2trimethoxysilylethane, 1-dimethylphosphino-3-triethoxysilylpropane, 1-diethylphosphino-3-triethoxysilylpropane, 1-diphenylphosphino-3-triethoxysilylpropane, 1-diphenylphosphino-2-trichlorosilylethane, 1-diphenylphosphino-2-trisdimethylaminosilylethane, 1-diphenylphosphino-2-triisocyanatosilylethane and 1-diphenylphosphino-4-triethoxysilylethylbenzene.

In addition, the problem is solved by a material for forming copper undercoat films, characterized in that the material for forming copper undercoat films is brought into contact with the substrate surface, thus forming the copper undercoat film.

In addition, the problem is solved by a material for forming copper undercoat films, wherein the undercoat film is produced by the bonding of (R₁R₂)P—(R)n-Si groups to the substrate via Si—O bonding, and said undercoat film is designed so that the reaction between the —Si(X₁X₂X₃) groups and —OH groups at the substrate surface occurs in liquid phase.

In addition, the problem is solved by a material for forming copper undercoat films, wherein the undercoat film is produced by the bonding of (R₁R₂)P—(R)ₙ—Si groups to the substrate via Si—O bonding, and said undercoat film is designed so that the reaction between the —Si(X₁X₂X₃) groups and —OH groups at the substrate surface occurs in gas phase.

In addition, the problem is solved by a material for forming copper undercoat films, wherein the undercoat film is produced by the bonding of (R₁R₂)P—(R)ₙ—Si groups to the substrate via Si—O bonding, and said undercoat film is designed so that the reaction between the —Si(X₁X₂X₃)groups and —OH groups at the substrate surface occurs in a supercritical liquid.

In addition, the problem is solved by a material for forming copper undercoat films, characterized in that the reaction between the —Si(X₁X₂X₃) groups and —OH groups at the substrate surface is carried out under the condition of room temperature to 450° C.

Specifically, when (R₁R₂)P—(R)ₙ—Si groups are affixed to the substrate surface, even at a thickness of a few tens of angstroms, and a copper film is formed thereupon, copper diffusion is effectively prevented, binding of the copper film is firm, and the resulting material resists peeling.

The functional molecular film characterized as described above (i.e., film affixed to the substrate via Si-0 bonding of (R₁R₂)P—(R)ₙ—Si) is obtained by immersion in a solution containing the aforementioned compound. Specifically, by immersing the substrate in a solution containing the aforementioned compound, a reaction between the —Si (X₁X₂X₃) groups of the aforementioned compound and —OH groups at the substrate surface occurs in liquid phase, and a substrate is readily obtained in which (R₁R₂)P—(R)ₙ—Si groups are affixed via Si-0 bonding.

A gas phase method can also be used instead of the above liquid phase method. Specifically, the aforementioned compound is conducted to the substrate surface by chemical vapor deposition (CVD), and the reaction between the Si (X₁X₂X₃) in the aforementioned compound and the —OH groups at the substrate surface occurs in gas phase, so that a substrate is easily obtained in which the (R₁R₂)P—(R)ₙ—Si groups are affixed via Si—O bonding.

Alternatively, a technique can be used wherein the reaction between the —Si(X₁X₂X₃) groups and —OH groups at the substrate surface is carried out in supercritical liquid.

Alternatively, a technique can be used wherein the reaction between —Si(X₁X₂X₃) groups and —OH groups at the substrate surface is carried out under a condition of room temperature to 450° C.

### BRIEF DESCRIPTION OF THE DRAWINGS

FIG. 1 is a schematic diagram of the film formation device (CVD), wherein reference numbers 1a and 1b are raw material containers; 3 is a heater; 4 is a decomposition reactor; 5 is the substrate; 6 is the reaction gas; and 7 is the carrier gas. FIG. 1 also shows a gas regulator, a gas discharge shower head 9 and exhaust.

### EMBODIMENTS OF THE INVENTION

The material for forming undercoat films for copper conductor films comprises the compound represented by general formula (1) below:

(R₁R₂)P—(R)ₙ—Si(X₁X₂X₂)

In general formula (I), at least one of X₁, X₂ and X₃ is a hydrolytic group, and specifically, a hydrolytic group that can react with the —OH groups at the substrate surface, thus forming free HX and generating (R₁R₂)P—(R)ₙ—Si—O-substrate bonding. Among these substances, any substance selected from a group consisting of halogens, alkoxide groups, amino groups and isocyanate groups may be used. R₁ and R₂ are alkyl groups, and specifically, alkyl groups with carbon numbers of 1-21, and more specifically, alkyl groups with carbon numbers of 1-14. R denotes a chain-form organic group formed from alkyl groups, aromatic rings or alkyl groups containing aromatic rings, and in particular, a chain-form organic group having a carbon number of 1-50, which is formed from alkyl groups, aromatic groups or alkyl groups containing aromatic rings, and more specifically, a chain-form organic group with a carbon number of 1-5, which is formed from alkyl groups, aromatic rings or alkyl groups containing aromatic rings, and n is an integer from 1 to 6.

Among the compounds represented by general formula (I) above, preferred compounds are 1-dimethylphosphino-2-triethoxysilylethane, 1-diethylphosphino-2-triethoxysilylethane, 1-diphenylphosphino-2triethoxysilylethane, 1-dimethylphosphino-2-trimethoxysilylethane, 1-diethylphosphino-2-trimethoxysilylethane, 1-diphenylphosphino-2-trimethoxysilylethane, 1-dimethylphosphino-3triethoxysilylpropane, 1-diethylphosphino-3-triethoxysilylpropane, 1-diphenylphosphino-3-triethoxysilylpropane, 1-diphenylphosphino-2-trichlorosilylethane, 1-diphenylphosphino-2-trisdimethylaminosilylethane, 1-diphenylphosphino-2-triisocyanatosilylethane and 1-diphenylphosphino-4-triethoxysilylethylbenzene.

The material for forming copper conductor undercoat films of the present invention is a material for forming a copper undercoat film on a substrate to be provided with a copper film, where the material for forming copper undercoat films is brought into contact with a substrate surface. In particular, the method for forming an undercoat film for copper conductor films on a substrate to be provided with a copper conductor film involves a process in which the aforementioned material for forming copper undercoat films is brought into contact with the substrate surface, and a process in which reaction side products generated in the aforementioned process are removed from the substrate surface. For example, a functional molecular film characterized as described above (film affixed to the substrate via Si—O bonding of (R₁R₂)P—(R)ₙ—Si is obtained by means of immersion in a solution containing the aforementioned compound. Specifically, by immersing the substrate in a solution containing the aforementioned compound, a reaction between the —Si(X₁X₂X₃) groups in the aforementioned compound and the —OH groups at the substrate surface occurs in liquid phase, thus allowing easy production of a substrate in which (R₁R₂)P—(R)ₙ—Si groups are affixed via Si-0 bonding. A vapor phase method also can be used instead of a liquid phase method. For example, the aforementioned compound can be transported to the substrate surface by means of CVD, and the reaction between the —Si(X₁X₂X₃)groups in the aforementioned compound and the —OH groups at the substrate surface occurs in gas phase, so that a substrate can be readily obtained in which the (R₁R₂)P—(R)ₙ—Si groups are affixed via Si—O bonding. Alternatively, a technique may be adopted wherein the reaction between the —Si(X₁X₂X₃) groups and the —OH groups at the substrate surface occurs in supercritical liquid. The reaction between the —Si(X₁X₂X₃)groups and —OH groups at the substrate surface is carried out under the condition of room temperature (eg, 25° C.) to 450° C.

Specific examples are presented below in order to describe the invention.

### EXAMPLE 1

A silicon substrate having an SiO₂ thermal oxide film formed at its surface was used as the substrate, the substrate surface was subjected to an Si—OH termination treatment, and the substrate was immersed in a toluene solution containing 1 vol % of 1-diphenylphosphino-2-triethoxysilylethane heated at 60° C. After 1 hour, the substrate was removed and washed with toluene before drying. Then by heating the substrate for 4 minutes at 120° C., the residual solvent was eliminated, thereby preventing side reactions.

The surface of the substrate obtained in this manner was subjected to measurements with a reflectance meter, and it was determined that a thin uniform film with a thickness of about 1.2 nm had been formed. As a result of FT-IR measurements performed on this thin film, a peak corresponding to Ph₂PCH₂CH₂SiO— was observed.

After formation of the above thin film, a copper thin film with a thickness of 100 nm was formed by CVD using copper hexafluoroacetylacetonate trimethylvinylsilane adduct as raw material. Subsequently, binding of the copper thin film was investigated using a tape peeling test. No peeling was observed in this example, whereas peeling occurred when the undercoat film was a conventional barrier metal.

Diffusion of copper into the undercoat film was investigated by backside SIMS. However, no copper diffusion was found.

### EXAMPLES 2-13

The same procedure as in Example 1 was carried out, with the exception that the 1-diphenylphosphino-2triethoxysilylethane used in Example 1 was changed to 1-dimethylphosphino-2-triethoxysilylethane (Example 2), 1-diethylphosphino-2-triethoxysilylethane (Example 3), 1-dimethylphosphino-2-trimethoxysilylethane (Example 4), 1-diethylphosphino-2-trimethoxysilylethane (Example 5), 1-diphenylphosphino-2-trimethoxysilylethane (Example 6), 1-dimethylphosphino-3-triethoxysilylpropane (Example 7), 1diethylphosphino-3-triethoxysilylpropane (Example 8), 1-diphenylphosphino-3-triethoxysilylpropane (Example 9), 1-diphenylphosphino-2-trichlorosilylethane (Example 10), 1-diphenylphosphino-2trisdimethylaminosilylethane (Example 11), 1-diphenylphosphino-2-triisocyanatosilylethane (Example 12) and 1-diphenylphosphino-4-triethoxysilylethylbenzene (Example 13).

As a result, in all of the examples, films were formed having thicknesses of 1.2-2.2 nm with structures in which (R₁R₂)P—(R)ₙ—Si groups were bonded to the substrate via Si—O bonding. Upon investigating the binding of copper thin film using a tape peeling test, no peeling of the copper thin film was found. In addition, upon investigating copper dispersion into the undercoat film using backside SIMS, no copper diffusion was observed.

### EXAMPLES 14-26

A similar procedure was carried out using a silicon substrate provided with an alkylsilicone-based low-dielectric film instead of the silicon substrate having an SiO₂ thermal oxide film on its surface as in Examples 1-13.

In all of these examples, films were formed having thicknesses of 1.2-2.2 nm with structures in which (R₁R₂)P—(R)ₙ—Si groups were bonded to the substrate via Si—O bonding. Upon investigating binding of the copper thin films by means of tape peeling tests, no peeling of the copper thin film was found. In addition, upon investigating copper dispersion into the undercoat film by means of backside SIMS, no copper diffusion was observed.

### EXAMPLE 27

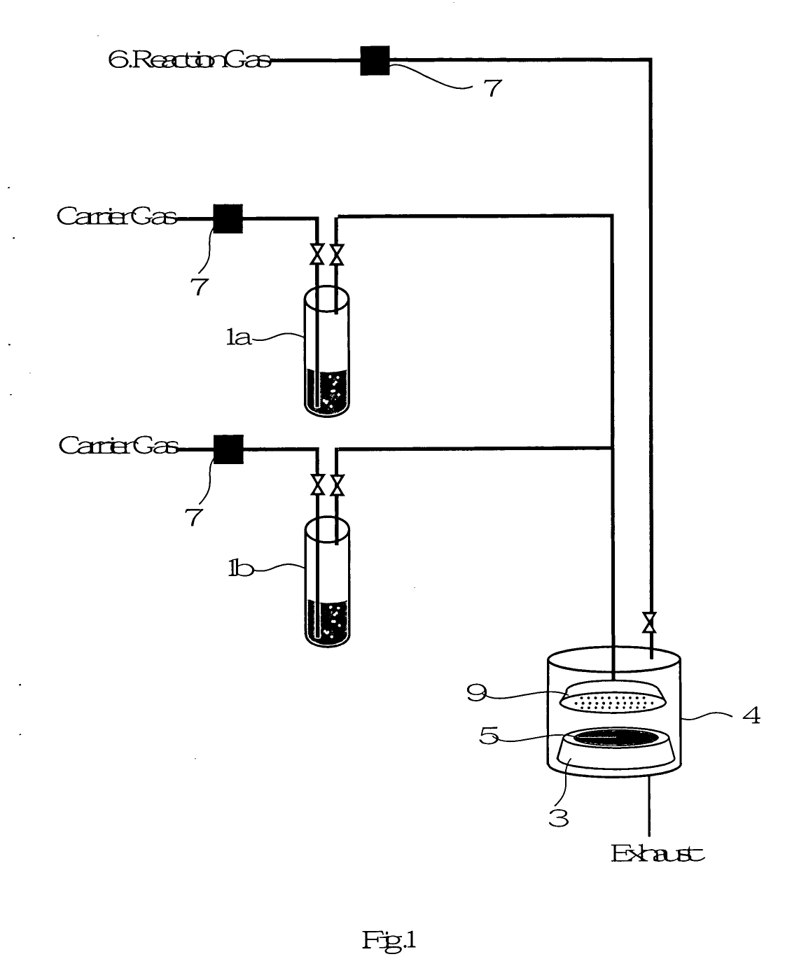

FIG. 1 is a schematic diagram of a film formation device (MOCVD). In the figure, 1a and 1b are raw material containers, 3 is a heater, 4 is a decomposition reaction furnace, 5 is a substrate and 9 is a gas discharge shower head.

Container 1a contained 1-dimethylphosphino-2-trimethoxysilylethane and was maintained at 90° C., whereas container 1b contained water and was maintained at room temperature. Argon carrier gas was blown into containers 1a and 1b at a rate of 1-10 mL/min, the interior of the decomposition reactor 4 was maintained at 1-100 Pa, and the substrate temperature was maintained at 40-200° C. First, the substrate surface was subjected to an —OH conversion treatment by means of introducing water vapor, whereupon film growth was carried out by introducing 1-dimethylphosphino-2-trimethoxysilylethane.

The surface of the substrate produced in this manner was subjected to measurement with a reflectance meter, and it was determined that a uniform thin film with a thickness of 1.2 nm had been formed. This thin film was then subjected to FT-IR measurements, and a peak corresponding to Ph₂PCH₂CH₂SiO—was observed.

After forming the above thin film, a copper thin film with a thickness of 140 nm was formed by CVD using copper hexafluoroacetylacetonate trimethylvinylsilane adduct as raw material. Upon investigating copper thin film binding by the tape-peeling test, no peeling was observed in this example, in spite of the fact that peeling was observed when the coating film was a conventional barrier metal. Copper diffusion in the undercoat film was investigated by backside SIMS, and no copper diffusion was found.

In addition, a similar procedure was carried out using a silicon substrate provided with an alkylsiliconebased low dielectric film instead of the aforementioned silicon substrate, and the same tests were carried out. The material exhibited similar characteristics.

### EXAMPLES 28-29

The same procedure as in Example 27 was carried out, with the exception that 1-dimethylphosphino-2triethoxysilylethane (Example 28), 1-diethylphosphino-2-triethoxysilylethane (Example 29), 1dimethylphosphino-2-trimethoxysilylethane (Example 30), 1-diethylphosphino-2-triethoxysilylethane (Example 31), 1-diphenylphosphino-2-trimethoxysilylethane (Example 32), 1-dimethylphosphino-3triethoxysilylpropane (Example 33), 1-diethylphosphino-3-triethoxysilylpropane (Example 34), 1diphenylphosphino-3-triethoxysilylpropane (Example 35), 1-diphenylphosphino-2-trichlorosilylethane (Example 36), 1-diphenylphosphino-2-trisdimethylaminosilylethane (Example 37), 1-diphenylphosphino-2-triisocyanatosilylethane (Example 38) and 1-diphenylphosphino-4-triethoxysilylethylbenzene (Example 39) were used instead of the 1-diphenylphosphino-2-triethoxysilylethane used in Example 27.

As a result, in all of these examples, films were formed having thicknesses of 1.2-2.2 run with structures in which (R₁R₂)P—(R)ₙ—Si groups were bonded to the substrate via Si—O bonding. As a result of investigating the binding of copper thin film using a tape peeling test, no peeling of the copper thin film was found. In addition, upon investigating copper dispersion into the undercoat film by means of backside SIMS, no copper diffusion was observed.

### EXAMPLE 40

A silicone substrate having a SiO₂ thermal oxide film formed on its surface was used as the substrate. The substrate surface was subjected to an Si—OH termination treatment, whereupon the substrate was placed in a reaction chamber, and was brought into contact with CO₂ supercritical liquid containing 1 vol % of 1-diphenylphosphino-2-triethoxysilylethane heated to 60° C. After a period of 1 h, the material was washed with CO₂ supercritical liquid without removing it from the reaction chamber, and the substrate was then heated for 4 min at 120° C. in CO₂ supercritical liquid.

The surface of the substrate obtained in the manner described above was subjected to measurements with a reflectance meter, and it was determined that a nearly uniform thin film with a thickness of 1.2 nm had been formed. As a result of FT-IR measurements carried out on the thin film, a peak corresponding to Ph₂PCH₂CH₂SiO—was observed.

After forming the above thin film, a copper thin film with a thickness of 100 nm was formed by CVD using copper hexafluoroacetylacetonate trimethylvinylsilane adduct as raw material. Upon investigating copper thin film binding using a tape peeling test, no peeling was observed in this example, in spite of the fact that peeling was observed when the coating film was a conventional barrier metal. Also, Copper diffusion in the undercoat film was investigated by backside SIMS, and no copper diffusion was found.

### EFFECT OF THE INVENTION

An undercoat film can be formed that prevents copper diffusion and has excellent copper conductor film binding, even when thin. As a result, high-performance semiconductor equipment can be produced.

What is claimed is:

1. A material for forming copper undercoat films, characterized by comprising the compound represented by general formula (1) below:
(R₁R₂)P⁻(R)n⁻Si(X₁X₂X₃) General formula (I)
(In general formula 1, at least one of X₁, X₂ and X₃ is a hydrolytic group, R₁ and R₂ are alkyl groups, R denotes a chain-form organic group formed from alkyl groups, aromatic rings or alkyl groups containing aromatic rings, and n is an integer from 1 to 6.).

2. A material for forming copper undercoat films, characterized by comprising compound represented by general formula (1) below:
(R₁R₂)P—(R)n-Si(X₁X₂X₃) General formula (I)
(In general formula 1, at least one of X₁, X₂ and X₃ is selected from a group comprising halogens, alkoxide groups, amino groups and isocyanate groups, R₁ and R₂ are alkyl groups with carbon numbers of 1-21, R has a carbon number of 1-50, and denotes a chain-form organic group formed from alkyl groups, aromatic rings or alkyl groups containing aromatic rings, and n is an integer from 1 to 6.).

3. The material for forming copper undercoat films according to claim 1 or 2, characterized by being a material for forming copper undercoat films by virtue of the bonding of (R₁R₂)P—(R)n-Si groups to a substrate via Si—O bonding, and by comprising solvent and the compound represented by general formula (I).

4. The material for forming copper undercoat films according to any of claims 1-3, characterized in that the compound represented by general formula (I) is one or more substances selected from the group: 1-dimethylphosphino-2-triethoxysilylethane, 1-diethylphosphino-2-triethoxysilylethane, 1-diphenylphosphino-2-triethoxysilylethane, 1-dimethylphosphino-2-trimethoxysilylethane, 1-diethylphosphino-2trimethoxysilylethane, 1-diphenylphosphino-2-trimethoxysilylethane, 1-dimethylphosphino-3triethoxysilylpropane, 1-diethylphosphino-3-triethoxysilylpropane, 1-diphenylphosphino-3-triethoxysilylpropane, 1-diphenylphosphino-2-trichlorosilylethane, 1-diphenylphosphino-2trisdimethylaminosilylethane, 1-diphenylphosphino-2-triisocyanatosilylethane and 1-diphenylphosphino-4-triethoxysilylethylbenzene.

5. The material for forming copper undercoat films according to any of claims 1-4, characterized in that the material for forming copper undercoat films is brought into contact with a substrate surface, thus forming a copper undercoat film.

6. The material for forming copper undercoat films according to any of claims 1-5, wherein the undercoat film is produced by the bonding of (R₁R₂)P—(R)ₙ—Si groups to the substrate via Si—O bonding, and said undercoat film is the reaction between the —Si(X₁X₂X₃) and —OH at the substrate surface occurs in liquid phase.

7. The material for forming copper undercoat films according to any of claims 1-5, wherein the undercoat film is produced by the bonding of (R₁R₂)P—(R)ₙ—Si groups to the substrate via Si—O bonding, and said undercoat film is the reaction between the —Si(X₁X₂X₃) and —OH at the substrate surface occurs in liquid phase.

8. The material for forming copper undercoat films according to any of claims 1-5, wherein the undercoat film is produced by the bonding of (R₁R₂)P—(R)n—Si groups to the substrate via Si—O bonding, and said undercoat film is the reaction between the —Si(X₁X₂X₃) and —OH at the substrate surface occurs in a supercritical liquid.

9. The material for forming copper undercoat films according to any of claims 1-8, characterized in that the reaction between the —Si(X₁X₂X₃) and —OH at the substrate surface is carried out under the condition of room temperature to 450° C.
